(19) United States
(12) Patent Application Publication
(10) Pub. No.: US 2008/0013032 A1
(43) Pub. Date: Jan. 17, 2008

(54) Liquid crystal device

(75) Inventors: Hiroshi Tsukada, Sayama-shi (JP); Makoto Kurihara, Kawagoe-shi (JP); Jun Chiba, Tokorozawa-shi (JP)

Correspondence Address: Finnegan, Henderson, Farabow,;Garrett & Dunner, L.L.P., 901 New York Avenue, N.W., Washington, DC, 20001-4413, US

(73) Assignee: CITIZEN WATCH CO., LTD.

(21) Appl. No.: 11/091,753

(22) Filed: Mar. 29, 2005

(30) Foreign Application Priority Data
Mar. 31, 2004 (JP) 2004-101652

(51) Int. Cl. G02F 1/1339

(52) U.S. Cl. 349/155

(57) ABSTRACT

An object of the present invention is to provide a liquid crystal device wherein provisions are made to reduce the occurrence of light leakage and discrimination. The liquid crystal device comprises a pair of opposing substrates, a liquid crystal provided between the pair of opposing substrates, and spacers for maintaining a gap between the pair of opposing substrates, wherein the spacers include a mixture of coated spacers, each coated with an alignment material for giving liquid crystal molecules forming the liquid crystal a tendency to align in a particular direction around the surface of the spacer, and uncoated spacers not coated with an alignment material.

Applicant claims the right to priority based on Japanese Patent Application No. 2004-101652, filed on Mar. 31, 2004.

### TECHNICAL FIELD

The present invention relates to a liquid crystal device and, more particularly, to a liquid crystal device having prescribed spacers.

### BACKGROUND ART

Generally, a liquid crystal display device comprises a pair of transparent substrates arranged opposite each other on top and bottom and each having a transparent electrode and an alignment film, and a liquid crystal filled between the top and bottom substrates. Spacers are inserted between the pair of substrates to provide a prescribed gap therebetween.

FIG. 5 shows a cross-sectional view of a prior art liquid crystal device.

As shown in FIG. 5, the liquid crystal device 20 includes a pair of transparent substrates, i.e., a top substrate 1 and a bottom substrate 11. The top substrate 1 comprises a top transparent substrate 2, a top transparent electrode 3 formed on the lower surface thereof, and a top alignment film 4 formed over the top transparent electrode 3. Likewise, the bottom substrate 11 comprises a bottom transparent substrate 12, a bottom transparent electrode 13 formed on the upper surface thereof, and a bottom alignment film 14 formed over the bottom transparent electrode 13. Spacers 17 are inserted between the top and bottom substrates to provide a prescribed gap therebetween, and a liquid crystal 16 is sealed in the gap by means of a sealing member 18. Further, a top polarizer 5 is attached to the upper surface of the top substrate 1, and a bottom polarizer 15 to the lower surface of the bottom substrate 11.

However, the liquid crystal device 20 using the spacers 17 has the problem that bright spots appear around the spacers.

FIG. 6 is an explanatory diagram for explaining the alignment of liquid crystal molecules around a spacer. FIG. 6A is an enlarged cross-sectional view schematically showing the alignment of the liquid crystal molecules in the vicinity of the spacer, and FIG. 6B is an enlarged plan view showing the spacer of FIG. 6A as seen from above.

As shown in FIG. 6A, in the absence of an applied voltage, the liquid crystal molecules 16b near the surface of the spacer 17 are already abnormally aligned so as to be along the surface of the spacer 17. As shown in FIG. 6B, a bright spot A appears in the region of the abnormal alignment around the spacer 17. The bright spot A occurs regardless of whether the liquid crystal is being driven or not. Light leakage through such bright spots is one of the factors that contribute to reducing the contrast of the liquid crystal device and degrading the display quality.

A technique for preventing such light leakage is described in Patent Document 1 (JP-A-2001-133788).

According to the technique disclosed in Patent Document 1, a coating layer is provided on the surface of each spacer. For the coating material, a graft polymer is used that contains long-chain alkyl groups with a carbon number of 10 to 22 and at least one kind of substituent group selected from the group consisting of an isobornyl group, a norbornyl group, a t-butylcyclohexyl group and an adamantyl group. The core of the spacer is formed by polymerizing polymerizable monomers having ethylenically unsaturated groups. At least 20% by weight of the polymerizable monomers having ethylenically unsaturated groups are polymerizable monomers having two or more ethylenically unsaturated groups.

FIG. 7 shows an explanatory diagram for explaining the alignment of the liquid crystal molecules around a spacer having such a coating layer.

It is claimed that when the spacer having the above coating layer is used, the liquid crystal molecules 16c align in directions perpendicular to the spacer 27 as shown in FIG. 7A. According to Patent Document 1, it is speculated that the liquid crystal molecules exhibit a tendency to align perpendicularly to the surface of the spacer because it becomes easier for the liquid crystal molecules to align along the long-chain alkyl groups.

When various experiments were conducted using spacers consisting only of those having the coating layers that induce the above-described perpendicular alignment, no light leakage was observed. However, it was found that thin line-like light leakage occurs. After detailed examination of the cause, the present inventor discovered that such thin line-like light leakage (discrimination) occurs between adjacent spacers.

As shown in FIG. 7B, when spacers 27a and 27b, each having the coating layer that induces the perpendicular alignment, are located adjacent to each other at a pitch p, the liquid crystal molecules 16c located between the spacers are abnormally aligned in a direction C which is different from the alignment direction (in the absence of an applied voltage) B of the liquid crystal molecules. It is speculated that this behavior of the liquid crystal molecules 16c results in the occurrence of thin line-like light leakage. Occurrence of such discrimination impairs the display image quality of the liquid crystal display device and decreases the production yield.

### SUMMARY OF THE INVENTION

It is an object of the present invention to provide a liquid crystal device wherein provisions are made to reduce the occurrence of light leakage and discrimination and improve the display image quality, while also improving the production yield.

A liquid crystal device according to the present invention comprises a pair of opposing substrates, a liquid crystal provided between the pair of opposing substrates, and spacers for maintaining a gap between the pair of opposing substrates, wherein the spacers include a mixture of coated spacers, each coated with an alignment material for giving liquid crystal molecules forming the liquid crystal a tendency to align in a particular direction around the surface of the spacer, and uncoated spacers not coated with an alignment material.

In the liquid crystal device according to the present invention, the mixing ratio of the coated spacers to the uncoated spacers is preferably in the range of 80%:20% to 20%:80% by quantity.

Further preferably, in the liquid crystal device according to the present invention, the particle size of the coated spacers is larger than the particle size of the uncoated spacers.

A liquid crystal device according to the present invention comprises a pair of opposing substrates, a liquid crystal provided between the pair of opposing substrates, and spacers for maintaining a gap between the pair of opposing substrates, wherein the spacers include a mixture of first spacers having a strong alignment function for giving an alignment tendency to liquid crystal molecules forming the liquid crystal and second spacers having a weak alignment function.

In the liquid crystal device according to the present invention, the mixing ratio of the first spacers to the second spacers is preferably in the range of 80%:20% to 20%:80% by quantity.

Further preferably, in the liquid crystal device according to the present invention, the particle size of the first spacers is larger than the particle size of the second spacers.

Preferably, in the liquid crystal device according to the present invention, the first spacers are each coated with a perpendicular alignment material for giving the liquid crystal molecules forming the liquid crystal a tendency to align perpendicularly to the surface of the spacer, and the second spacers are not coated with the perpendicular alignment material.

In the present invention, the coated spacers (or the first spacers having a strong perpendicular alignment function) and the uncoated spacers (or the second spacers having a weak perpendicular alignment function) are mixed together such that the coated spacers serve to reduce the rate of occurrence of light leakage around the spacer surfaces while the presence of the uncoated spacers serves to reduce the rate of occurrence of discrimination. Accordingly, the liquid crystal device according to the present invention achieves an improvement in image quality or display quality. Furthermore, the liquid crystal device according to the present invention can be produced with high production yield and achieves a reduction in production cost.

Further, the mixing ratio of the coated spacers (or the first spacers having a strong perpendicular alignment function) to the uncoated spacers (or the second spacers having a weak perpendicular alignment function) is preferably set within the range of 80%:20% to 20%:80% by quantity. When the mixing ratio is set within the above range, the discrimination hardly occurs and, while light leakage may become visible in places, a liquid crystal device having a practically acceptable image quality or display quality can be obtained.

### BRIEF DESCRIPTION OF THE DRAWINGS

FIG. 1 is a cross-sectional view showing an essential portion of a liquid crystal device according to the present invention.

FIG. 2 is a diagram for explaining the function of spacers in the liquid crystal device according to the present invention.

FIGS. 3A and 3B are diagrams for explaining the gap adjustment between the substrates of the liquid crystal device.

FIG. 4 is a diagram showing the relationship between a coating material forming s coating layer and the image quality.

FIG. 5 is a cross-sectional view showing an essential portion of a prior art liquid crystal device.

FIG. 6A is an enlarged cross-sectional view schematically showing the alignment of liquid crystal molecules in the vicinity of a spacer, and FIG. 6B is an enlarged plan view showing the spacer of FIG. 6A as seen from above.

FIG. 7A is an enlarged cross-sectional view schematically showing the alignment of liquid crystal molecules around the surface of a spacer, and FIG. 7B is a diagram for explaining the occurrence of discrimination.

### DESCRIPTION OF THE PREFERRED EMBODIMENTS

A liquid crystal device according to the present invention will be described below with reference to the drawings. It should be understood, however, that the invention is not limited to the embodiment illustrated in the drawings.

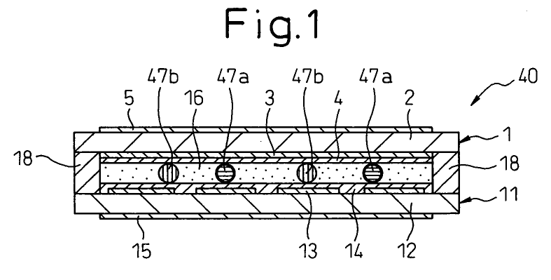

FIG. 1 is a cross-sectional view showing an essential portion of the liquid crystal device according to the present invention.

As shown in FIG. 1, the liquid crystal device 40 includes a pair of transparent substrates, i.e., a top substrate 1 and a bottom substrate 11, arranged opposite each other. The top substrate 1 comprises a top transparent substrate 2 formed from transparent glass, a top transparent electrode 3 formed from an ITO (Indium Tin Oxide) film deposited on the lower surface thereof, and a top alignment film 4 formed from a polyimide resin deposited over the top transparent electrode 3. Likewise, the bottom substrate 11 comprises a bottom transparent substrate 12 formed from transparent glass, a bottom transparent electrode 13 formed from an ITO film deposited on the upper surface thereof, and a bottom alignment film 14 formed from a polyimide resin deposited over the bottom transparent electrode 13.

Further, in the liquid crystal device 40, coated spacers 47a and uncoated spacers 47b, both of the same particle size, are inserted between the top substrate 1 and the bottom substrate 11 to provide a prescribed gap therebetween, and a liquid crystal 16 is sealed in the gap by means of a seal member or a sealant member 18.

Further, a top polarizer 5 is attached to the upper surface of the top substrate 1, and a bottom polarizer 15 is attached to the lower surface of the bottom substrate 11.

Transparent glass has been used for the top and bottom transparent substrates 2 and 12. Soda glass, silica glass, borosilicate glass, ordinary sheet glass, or like material can be used as the glass. The thickness of the glass is preferably in the range of 0.3 mm to 1.1 mm. Instead of the glass substrates, plastic substrates or ceramic substrates may be used.

The ITO film of tin-doped indium oxide used to form each of the top and bottom transparent electrodes 3 and 13 has been deposited by such means as vacuum evaporation, sputtering, or CVD, and has been formed in the desired pattern by etching.

The top and bottom alignment films 4 and 14 have each been formed by applying a polyimide resin by such means as screen printing or spin coating, and treated with rubbing so as to align the liquid crystal material in a particular direction.

The sealant member 18 has a frame-like shape within which to seal the liquid crystal. The sealant member 18 has been formed around the periphery of one of the substrates by screen printing or the like. An opening (through which to inject the liquid crystal 16) has been formed in the sealant member 18. An epoxy sealant has been used as the sealant member 18, but other kinds of sealants may be used.

To fabricate the liquid crystal device 40, first the top substrate 1 and the bottom substrate 11 are registered with each other, and are bonded together via the sealant member 18 by heating the structure to a temperature of about 150° C. and applying a pressure of about 1 kg/cm², and then the liquid crystal is vacuum injected through the opening of the sealant member 18 into the gap between the top and bottom substrates 1 and 11, the opening then being sealed with an ultraviolet curing resin.

A TN mode liquid crystal has been used in the liquid crystal device 40, but use may be made of other nematic liquid crystals such as an STN mode liquid crystal.

Further, in the liquid crystal device 40, wiring electrodes for applying a voltage are connected to the top and bottom transparent electrodes 3 and 13, respectively, though not shown in the diagram.

As the liquid crystal device 40 uses a TN mode liquid crystal, the liquid crystal molecules align in the horizontal direction parallel to the top and bottom transparent electrodes 3 and 13 in portions where the voltage is not applied between the substrates, so that light does not pass through such portions. On the other hand, in portions where the voltage is applied between the top and bottom transparent electrodes 3 and 13, the liquid crystal molecules stand up and align perpendicularly to the substrates, allowing the light to pass through.

The coated spacers 47a are spacers each coated with a coating layer formed by applying a coating material that gives the liquid crystal molecules a tendency to align perpendicularly to the spacer surface. The uncoated spacers 47b are spacers not coated with the coating material that gives the liquid crystal molecules the tendency to align perpendicularly to the spacer surface.

In the liquid crystal device 40, these two kinds of spacers, i.e., the coated spacers 47a and the uncoated spacers 47b, are used by mixing them together.

An acrylic resin has been used as the spacer core material for both the uncoated spacers 47b and the coated spacers 47a before coating the latter with the coating layer. Besides an organic material such as an acrylic resin, an inorganic material such as glass or alumina can be selected for use as the spacer core material. However, when an inorganic material is used, a phenomenon such as the low temperature foaming of the liquid crystal layer may occur due to temperature variations, because the thermal expansion coefficient differs greatly between the liquid crystal and the inorganic material. Accordingly, it is preferable to use an organic material such as a resin as the spacer core material.

For the coating material that gives the liquid crystal molecules the tendency to align perpendicularly to the spacer surface, a graft polymer has been used that contains long-chain alkyl groups with a carbon number of 10 to 22 and at least one kind of substituent group selected from the group consisting of an isobornyl group, a norbornyl group, a t-butylcyclohexyl group and an adamantyl group.

The coating layer can be formed on the spacer by using the technique disclosed in the previously cited Patent Document 1 (see page 5). Since spacers coated with such coating layers are available on the market, such spacers may be used as the coated spacers 47a.

The mixing ratio of the coated spacers 47a to the uncoated spacers 47b is preferably in the range from 80%:20% to 20%:80% by quantity (to a total percentage of 100%).

When the mixing ratio is set within the above range, discrimination is hardly noticeable and, while light leakage occurs in places and may become visible in rare cases, the light leakage is not particularly noticeable, and image quality or display quality at an allowable or practically acceptable level can be obtained.

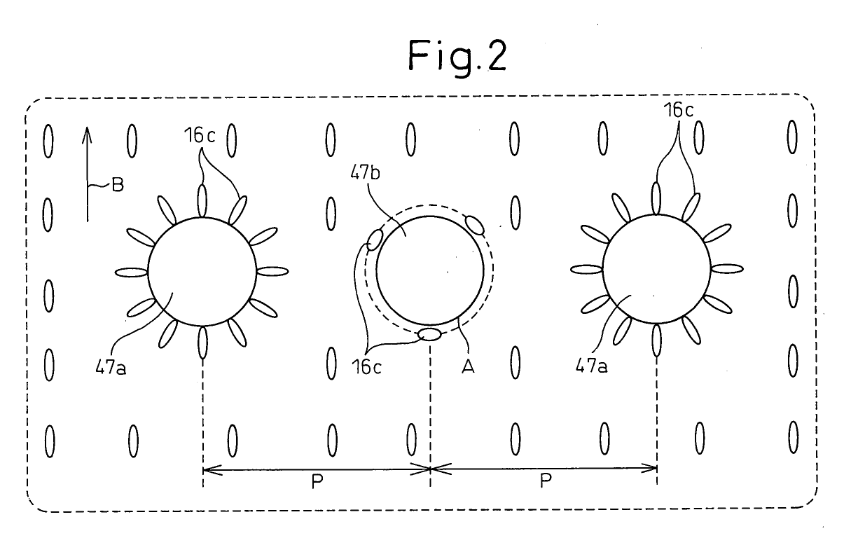

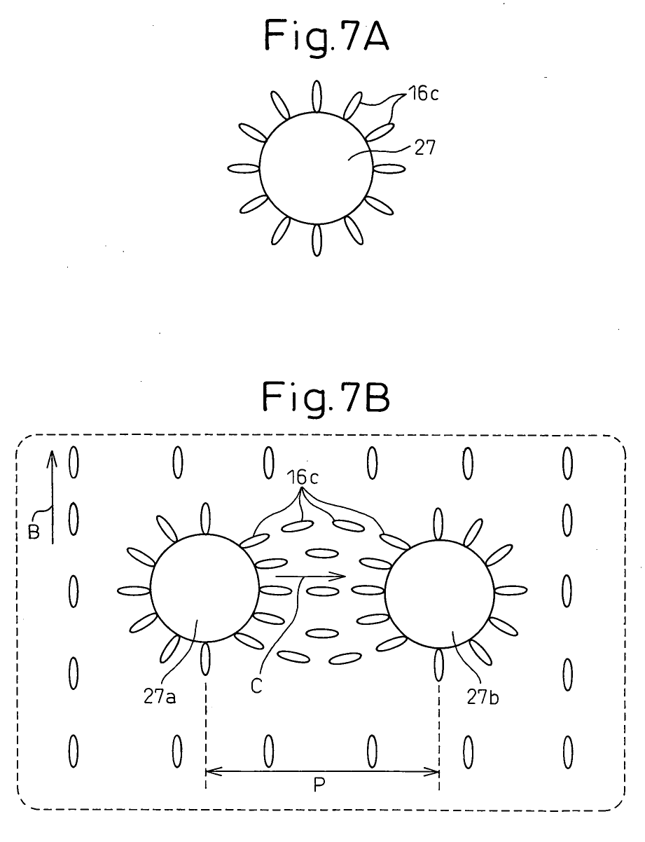

FIG. 2 shows an explanatory diagram for explaining how the liquid crystal molecules align around the spacers in the liquid crystal device according to the present invention. In FIG. 2, the coated spacers 47a and the uncoated spacer 47b arranged at a pitch p (see FIG. 7B) are shown as viewed from the top substrate 1 of the liquid crystal device 40. Further, arrow B shown in the figure indicates the alignment direction of the liquid crystal molecules (in the absence of an applied voltage).

As shown in FIG. 2, the liquid crystal molecules 16c located near the coated spacers 47a align in directions perpendicular to the respective coated spacers 47a; however, between the coated spacers 47a, the liquid crystal molecules are prevented from aligning abnormally because of the presence of the uncoated spacer 47b between the coated spacers 47a. Therefore, discrimination does not occur. A bright spot A occurs around the uncoated spacer 47b, but since all the spacers are not the uncoated spacers 47b, the degradation of the display quality of the liquid crystal device 40 as a whole is small or negligible.

Table 1 shows the light leakage and discrimination conditions evaluated by varying the mixing ratio of the coated spacers 47a to the uncoated spacers 47b. Here, spacers B7SP with a particle size 5.1 μm, manufactured by Natoco Co., Ltd., were used as the coated spacers 47a, and spacers with a particle size 5.1 μm, manufactured by Natoco Co., Ltd., were used as the uncoated spacers 47b. In Table 1, the following five spacer mixing ratios (of the uncoated spacers 47b to the coated spacers 47a) were used: (1) 100%:0%, (2) 80%:20%, (3) 50%:50%, (4) 20%:80%, and (5) 0%:100%. In each case, the two kinds of spacers were prepared with the prescribed mixing ratio, and mixed into a liquid mixture, for example, of 50% (10 to 50%) by weight of isopropyl alcohol and 50% (90 to 50%) by weight of water, and then the mixture was dispersed using a wet sprayer. After that, the display condition was evaluated on a liquid crystal device produced by injecting an STN mode liquid crystal therein. The quantity of spacers dispersed here was 120 spacers/mm², the quantity representing the total quantity of the uncoated spacers 47b and the coated spacers 47a. The liquid crystal device used for the evaluation was 400×300 mm in size.

TABLE 1

| | | EVALUATION OF | EVALUATION OF |
|---|---|---|---|
| COATED | UNCOATED | LIGHT LEAKAGE | DISCRIMINATION |
| 100% | 0% | D | A |
| 80 | 20 | C | B |
| 50 | 50 | B | B |
| 20 | 80 | B | B |
| 0 | 100 | A | D |

The evaluation was carried out by visually inspecting the display condition after applying a light impact 50 times. In Table 1, “D” indicates that light leakage or discrimination occurs at an extremely high rate and is distinctly visible, and therefore, the display condition is obviously bad. “C” indicates that the occurrence of light leakage is observed but the light leakage is not particularly noticeable as a whole because the degree of dispersion is large, and therefore, the display condition is within a practically acceptable range. “B” indicates that the occurrence of light leakage or discrimination is slightly observed but the defect is hardly noticeable, and therefore, there is no problem in use. “A” indicates that the occurrence of light leakage or discrimination is hardly observed.

From the results of Table 1, it can be seen that the mixing ratio of the uncoated spacers 47b to the coated spacers 47a should be set in the range from 80%:20% to 20%:80%.

The evaluation shown in Table 1 was carried out using an STN mode liquid crystal, but according to the verification made thereafter, it was verified that similar results can be obtained when a TN mode liquid crystal is used.

It should be noted here that the spacer dispersing quantity fairly affects the occurrence of discrimination. It has been confirmed that if the dispersing quantity is large and the spacing between adjacent spacers is small, discrimination can easily occur. Accordingly, it is preferable to set the spacer dispersing quantity somewhat smaller so as to increase the spacer spacing as much as possible. Generally, the spacer dispersing quantity is in the range of 100 to 200 spacers/mm², but it is preferable to set the quantity as close as possible to the lower limit but sufficient to withstand the pressure applied during the fabrication of the liquid crystal device.

In the above embodiment, the present invention has been described with reference to a liquid crystal device having a very simple structure, but the present invention can also be applied to an active matrix liquid crystal device that uses switching devices. In an active matrix liquid crystal device also, the same results as described above can be obtained when uncoated spacers are used by mixing them with coated spacers that give the liquid crystal molecules the tendency to align perpendicularly to the surfaces of the particle-like spacers.

In the above embodiment, two kinds of spacers have been used, but instead, multiple kinds of coated spacers and multiple kinds of uncoated spacers may be used in combination. Further, between the multiple kinds of coated spacers, the thickness of the coating layer may be varied.

In the above embodiment, the coated spacers 47a and the uncoated spacers 47b have been described as having the same particle size, but it is preferable to make the particle size of the coated spacers larger than that of the uncoated spacers. Usually, the gap between the top and bottom substrates 1 and 11 or the thickness of the liquid crystal layer is adjusted after disposing the spacers between the top and bottom substrates 1 and 11. Therefore, when the gap is adjusted, the spacers initially having a nearly true spherical shape become somewhat flattened in shape. Accordingly, if the coated spacers 47a and the uncoated spacers 47b have the same particle size, the uncoated spacers 47b also may become flattened in shape, increasing the contact area with the substrates and thus causing the bright spot around each uncoated spacer to expand. In view of this, when the particle size of the coated spacers 47a is made larger than that of the uncoated spacers 47b, the uncoated spacers 47b can be prevented from becoming flattened in shape. Here, it is preferable that the difference in particle size between the coated spacers 47a and the uncoated spacers 47b be made approximately equal to the amount of gap adjustment (for example, 0.1 μm). For example, the coated spacers 47a may be chosen to have an average particle size of 5.1 μm, and the uncoated spacers 47b to have an average particle size of 5.0 μm.

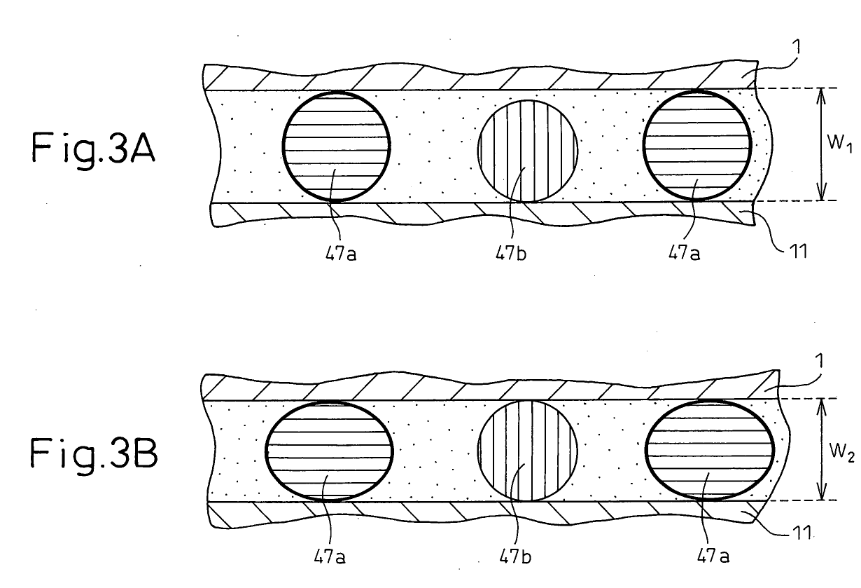

FIG. 3 shows an explanatory diagram illustrating the gap adjustment between the substrates.

FIG. 3A shows the condition in which the coated spacers 47a and the uncoated spacer 47b with a particle size smaller than that of the coated spacers 47a are disposed between the top and bottom substrates 1 and 11. In this case, the gap between the top and bottom substrates 1 and 11 is w1. FIG. 3B shows the condition in which the top and bottom substrates 1 and 11 are bonded together under pressure and the gap is reduced to w2 (the amount of gap adjustment=w1−w2). As shown in FIG. 3B, the coated spacers 47a are somewhat flattened in shape as a result of the gap adjustment, but the uncoated spacer 47b whose particle size is smaller than that of the coated spacers 47a is not flattened. In this way, by making the particle size of the coated spacers 47a larger than that of the uncoated spacers 47b, the occurrence of a bright spot around each uncoated spacer can be suppressed.

In the above embodiment, two kinds of spacers are used, that is, the coated spacers each having a coating layer formed from a coating material that gives the liquid crystal molecules the tendency to align perpendicularly, and uncoated spacers that do not have such coating layers. However, use may also be made of first spacers each having a coating layer formed from a coating material that has the function of giving the liquid crystal molecules a strong tendency to align perpendicularly, and second spacers each having a coating layer formed from a coating material that gives the liquid crystal molecules a weak tendency to align perpendicularly. Since the only requirement is that the first spacers, each having a coating layer formed from a coating material that has the function of giving the liquid crystal molecules the strong tendency to align perpendicularly, be prevented from being disposed adjacent to each other, to prevent the occurrence of thin line-like light leakage (discrimination) due to abnormal alignment of the liquid crystal molecules, spacers other than the completely uncoated spacers can be used.

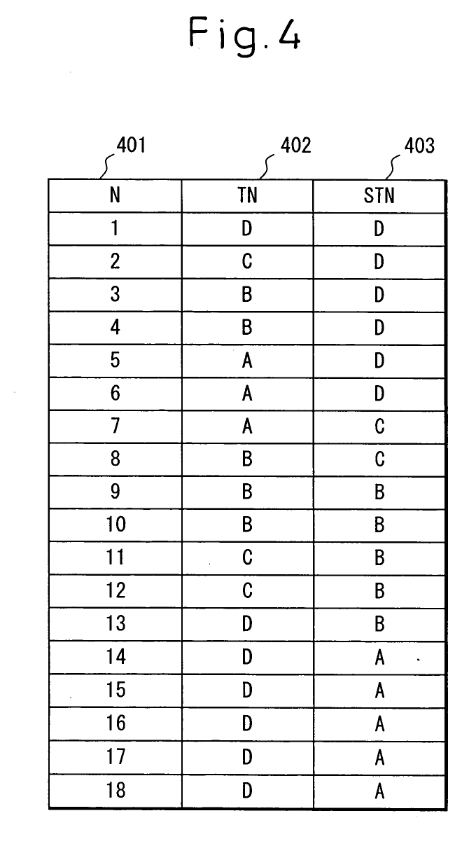

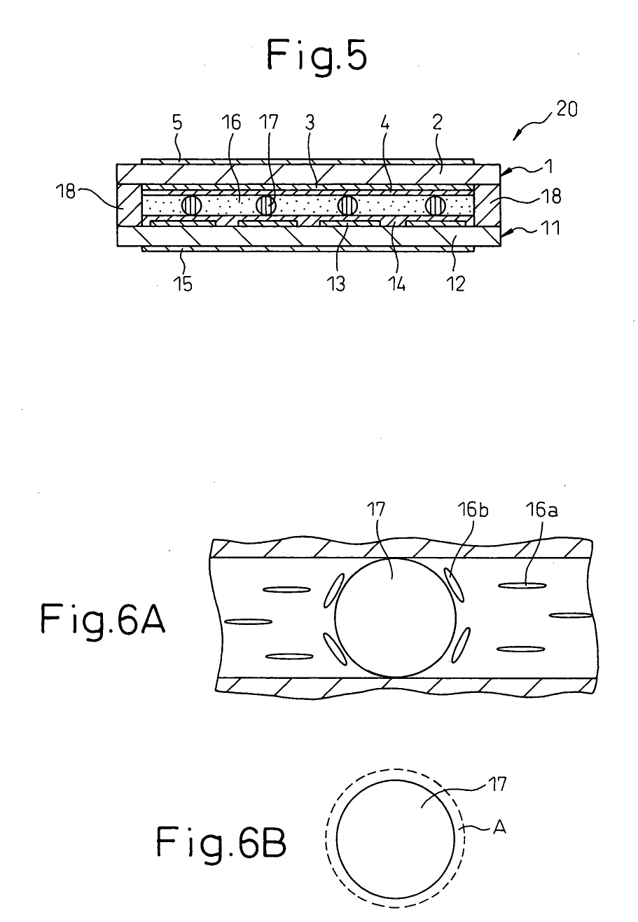

FIG. 4 is a diagram showing the relationship between the coating material forming the coating layer and the image quality.

In FIG. 4, reference numeral 401 indicates the average carbon number N of the long-chain alkyl groups contained in the coating material used to form the coating layer, 402 indicates the image quality of the TN liquid crystal for the corresponding average carbon number N, and 403 indicates the image quality of the STN liquid crystal for the corresponding average carbon number N.

Further, in FIG. 4, “D” indicates that light leakage occurs at an extremely high rate and is distinctly visible, and therefore, the display condition is obviously bad. “C” indicates that the occurrence of light leakage is observed but the light leakage is not particularly noticeable as a whole because the degree of dispersion of light leakage is large, and therefore, the display condition is within a practically acceptable range. “B” indicates that the occurrence of light leakage is slightly observed but the defect is hardly noticeable, and therefore, there is no problem in use. “A” indicates that the occurrence of light leakage is hardly observed.

From FIG. 4, it is seen that, for the TN liquid crystal, the coating material can give a strong perpendicular alignment tendency to the liquid crystal molecules if the carbon number of the long-chain alkyl groups in the material is in the range of 3 to 12, because the amount of light leakage is then small. It is also seen that, for the TN liquid crystal, the coating material can give a weak perpendicular alignment tendency to the liquid crystal molecules if the carbon number of the long-chain alkyl groups in the material is in the range of 1 to 3, or 13 or larger.

From FIG. 4, it is seen that, for the STN liquid crystal, the coating material can give a strong perpendicular alignment tendency to the liquid crystal molecules if the carbon number of the long-chain alkyl groups in the material is 7 or larger, because the amount of light leakage is then small. It is also seen that, for the STN liquid crystal, the coating material can give a weak perpendicular alignment tendency to the liquid crystal molecules if the carbon number of the long-chain alkyl groups in the material is in the range of 1 to 6.

The liquid crystal device 40 described in the above embodiment can be used not only as a liquid crystal display device, but also as an optical device or the like for limiting a light beam, as seen in a liquid crystal aberration correcting panel.

As described above, in the liquid crystal device according to the present invention, the spacers coated with a coating material that gives the liquid crystal molecules the tendency to align perpendicularly to the surfaces of the particle-like spacers and the spacers not coated with such a coating material are disposed in a mixed manner, thereby reducing the rate of occurrence of line-like light leakage and discrimination while also making the defect unnoticeable by spatially dispersing out such defects, and thus achieving the effect of enhancing the contrast and improving the display quality.

While the above embodiment has been described by dealing with a coating material that gives the liquid crystal molecules the tendency to align in perpendicular directions, it will be recognized that a material that gives the liquid crystal molecules a tendency to align in directions other than perpendicular directions can also be used.

What is claimed is:

1. A liquid crystal device comprising:
a pair of opposing substrates;
a liquid crystal provided between the pair of opposing substrates; and
spacers for maintaining a gap between the pair of opposing substrates, wherein
the spacers include a mixture of coated spacers, each coated with an alignment material for giving liquid crystal molecules forming the liquid crystal a tendency to align in a particular direction on the surface of the spacer, and uncoated spacers not coated with an alignment material mixture of.

2. The liquid crystal device according to claim 1, wherein the alignment material gives a perpendicular alignment tendency to the liquid crystal molecules.

3. The liquid crystal device according to claim 1, wherein the mixing ratio of the coated spacers to the uncoated spacers is in the range of 80%:20% to 20%:80% by quantity.

4. The liquid crystal device according to claim 1, wherein the particle size of the coated spacers is larger than the particle size of the uncoated spacers.

5. A liquid crystal device comprising:
a pair of opposing substrates;
a liquid crystal provided between the pair of opposing substrates; and
spacers for maintaining a gap between the pair of opposing substrates, wherein
the spacers include a mixture of first spacers having a strong alignment function for giving an alignment tendency to liquid crystal molecules forming the liquid crystal and second spacers having a weak alignment function.

6. The liquid crystal device according to claim 5, wherein the first spacers have a strong perpendicular alignment function for giving a perpendicular alignment tendency to the liquid crystal molecules, and the second spacers have a weak perpendicular alignment function for giving a perpendicular alignment tendency to the liquid crystal molecules.

7. The liquid crystal device according to claim 5, wherein the mixing ratio of the first spacers to the second spacers is in the range of 80%:20% to 20%:80% by quantity.

8. The liquid crystal device according to claim 5, wherein the particle size of the first spacers is larger than the particle size of the second spacers.

9. The liquid crystal device according to claim 6, wherein the first spacers are each coated with a perpendicular alignment material for giving the liquid crystal molecules forming the liquid crystal a tendency to align perpendicularly to the surface of the spacer, and the second spacers are not coated with the perpendicular alignment material.
